(19) United States
(12) Patent Application Publication
(10) Pub. No.: US 2008/0303329 A1
(43) Pub. Date: Dec. 11, 2008

(54) Chair or a Bed Having a Seat, a Backrest and an Armrest as Well as Use Thereof

(75) Inventor: Thomas Steen Nielsen, Brondby (DK)

Correspondence Address: WILLIAM J. SAPONE;COLEMAN SUDOL SAPONE P.C., 714 COLORADO AVENUE, BRIDGE PORT, CT, 06605, US

(73) Assignee: HEKA DENTAL APS, Ishoj (DK)

(21) Appl. No.: 11/995,346

(22) PCT Filed: Jul. 14, 2006
(86) PCT No.: PCT/DK2006/000416

§ 371 Date: Mar. 11, 2008

(30) Foreign Application Priority Data
Aug. 4, 2005 (DK) PA2005 01114

(51) Int. Cl. A47C 7/54; A61G 15/12

(52) U.S. Cl. 297/360

(57) ABSTRACT

A chair (1), in particular a dentist's chair, which has a seat (3) and a backrest (2) which are connected with each other by means of a hinge (6) consisting of two movable parts in the from of an inner ring (8) and an outer ring (7) disposed concentrically therewith. The inner ring (8) is secured to the seat (3), while the outer ring (7) is secured to the sear (3). The outer side of the inner ring (8) engages the inner side of the outer ring (7), a ball bearing (11, 12) being mounted between the inner ring (8) and the outer ring (7). The invention provides a dentist's chair where the armrest follows the movement of a user's back.

The invention relates to a chair or a bed, which comprises a seat or a support, a backrest and an armrest, where the back is movable relative to the seat.

The invention moreover relates to use of the chair or the bed.

Such a chair is known from WO 94/19991 A1. In this known chair, the backrest may be moved relative to the seat, as the backrest may be moved by means of a sliding arrangement which is provided between the armrest of the chair and the legs of the chair. Thus, the armrest itself cannot be moved.

Accordingly, an object of the invention is to provide a chair, where the backrest follows the movement of the armrest, which involves a greater comfort for a user of the chair and ensures that the headrest/back can only move minimally after adjustment.

The object of the invention is achieved by a chair of the type defined in the introductory portion of claim 1, which is characterized in that the backrest and the seat are secured to each other by means of the armrest, which is formed by a hinge consisting of two mutually movable parts, where the one part is secured to the seat, while the other part is secured to the backrest. Hereby, the armrest will follow the movement of the backrest.

A particularly expedient way of hinging the backrest to the seat is, as defined in claim 2, that the two mutually movable parts are configured as an inner ring and an outer ring which are disposed concentrically, where the outer side of the inner ring engages the inner side of the outer ring.

Further, it is expedient if, as stated in claim 3, a bearing, such as a ball bearing, is mounted between the inner ring and the outer ring, and, as stated in claim 4, that the inner ring is secured to the seat, while the outer ring is secured to the backrest.

A further comfort-enhancing feature of the chair is that the outer side of the outer ring is padded, as stated in claim 5.

As mentioned, the invention also relates to a use. This use is defined in claim 6.

The invention will now be explained with reference to the drawing, in which

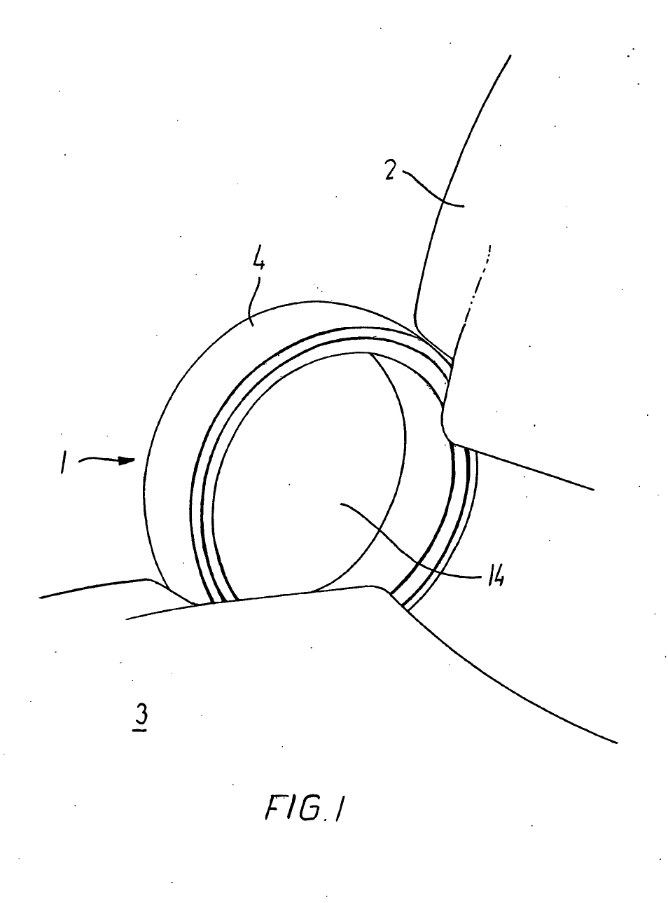

FIG. 1 shows the basic structure of a chair according to the invention,

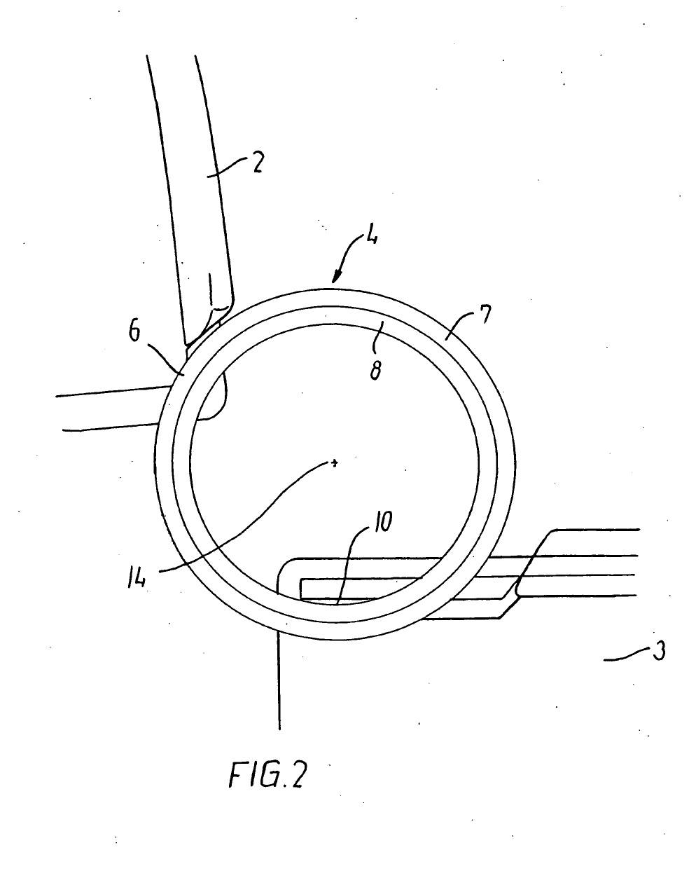

FIG. 2 shows a lateral section of the chair of FIG. 1, while

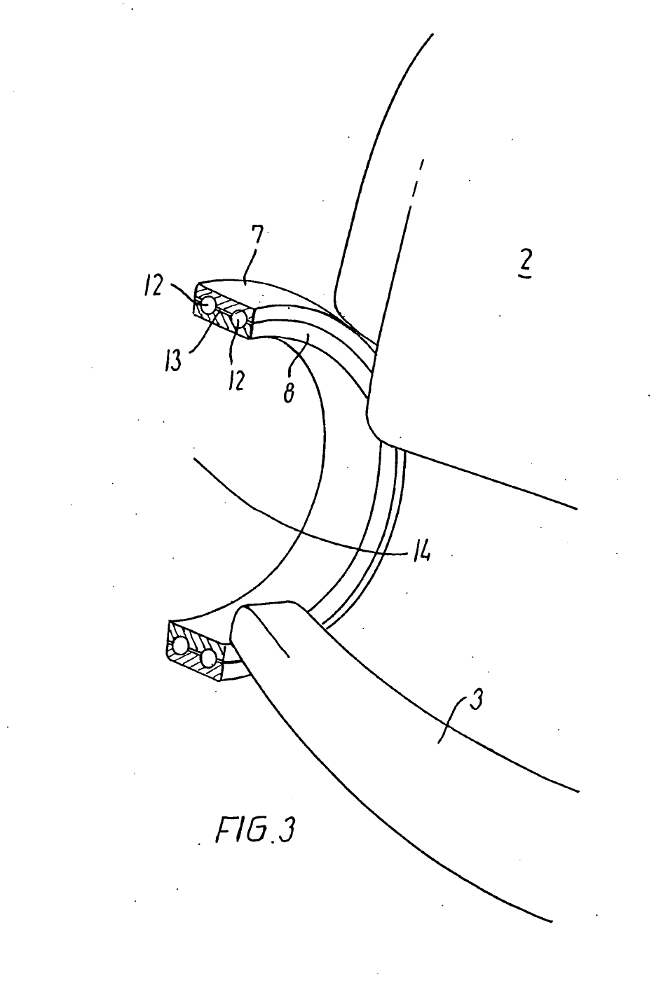

FIG. 3 shows how the armrest for the chair is constructed.

In FIG. 1, the numeral 1 designates a chair as a whole, which is shown here as a dentist's chair.

The chair has a backrest 2 which is connected with a seat 3 by means of two armrests 4 (only one is shown), as will be explained later.

As will be seen in FIGS. 2 and 3, the armrest 4 consists of an inner ring 8 which is secured to the seat 3, as shown at 10, by means of a bolt (not shown) or the like.

An outer ring 7 is provided concentrically with the inner ring 8, said outer ring being secured to the backrest 2, as shown at 6, by means of a bolt (not shown) or the like. A padding may be provided on the outer side of the outer ring.

The outer ring 7 and the inner ring 8 may be rotated relative to each other about a pivot 14, a bearing, cf. FIG. 3, being arranged between the outer ring and the inner ring, as shown at 11, 12.

As will be seen, the pivot 14 is disposed between the seat 3 and the backrest 2.

Finally, there is a small gap 13 between the outer ring 7 and the inner ring 8.

It should be noted that the movement between the inner ring and the outer ring may be provided by a motor (not shown) and/or by a pushing movement on the backrest and/or bracket/unit which is secured to the backrest.

The chair is operated in the following manner:

When a person sits in the chair and moves the backrest up or down, the outer ring of the armrest and the backrest will follow the movement and rotate relate to the inner ring, which gives a great user comfort, since a user need not release the armrest during the movement of the backrest or let his hand slide on the armrest.

1. A chair (1) or a bed, which comprises a seat (3) or a support, a backrest (2) and an armrest (6), where the backrest is movable relative to the seat, characterized in that the backrest (2) and the seat (3) are secured to each other by means of the armrest (6), which is formed by a hinge consisting of two mutually movable parts (7, 8), where the one part is secured to the seat (3), while the other part is secured to the backrest (2).

2. A chair according to claim 1, characterized in that the two mutually movable parts are configured as an inner ring (8) and an outer ring (7) which are disposed concentrically, where the outer side of the inner ring engages the inner side of the outer ring with or without bearing guide.

3. A chair according to claim 1, characterized in that a bearing (11, 12) is mounted between the inner ring (8) and the outer ring (7).

4. A chair according to claim 2, characterized in that the inner ring (8) is secured to the seat (3), while the outer ring (7) is secured to the backrest (2).

5. A chair according to claim 2, characterized in that the outer side of the outer ring (7) is padded.

6. Use of a chair or a bed according to claim 1 as a dentist's chair.

7. A chair according to claim 3 wherein the bearing is a ball bearing.

8. A chair according to claim 2, characterized in that a bearing (11, 12) is mounted between the inner ring (8) and the outer ring (7).

9. A chair according to claim 8 wherein the bearing is a ball bearing.

10. A chair according to claim 3, characterized in that the inner ring (8) is secured to the seat (3), while the outer ring (7) is secured to the backrest (2).

11. A chair according to claim 3, characterized in that the outer side of the outer ring (7) is padded.

12. A chair according to claim 4, characterized in that the outer side of the outer ring (7) is padded.
